(19) United States
(12) Patent Application Publication
(10) Pub. No.: US 2010/0075692 A1
(43) Pub. Date: Mar. 25, 2010

(54) DYNAMIC QUALITY OF SERVICE CONTROL TO FACILITATE FEMTO BASE STATION COMMUNICATIONS

(76) Inventors: Peter Busschbach, Basking Ridge, NJ (US); Dong Sun, New Providence, NJ (US); Frank Favichia, Sparta, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 12/424,008

(22) Filed: Apr. 15, 2009

Related U.S. Application Data
(63) Continuation-in-part of application No. 12/237,838, filed on Sep. 25, 2008.

(51) Int. Cl. H04W 72/08; H04W 4/00; H04W 40/00

(52) U.S. Cl. 455/452.2; 455/435.1; 455/445

(57) ABSTRACT

An exemplary method of facilitating communications involving a Femto base station (FBS) includes initiating a dedicated backhaul quality of service (QoS) request by the FBS. The request is based on at least an association between the FBS and a wireline backhaul resource used by the FBS. The QoS for the wireline backhaul resource is based on a QoS for a wireless communication session corresponding to the request.

### FIELD OF THE INVENTION

This invention generally relates to communication. More particularly, this invention relates to communications involving privately employed base stations such as Femto base stations.

### DESCRIPTION OF THE RELATED ART

Wireless communication systems are well known and in widespread use. Typical cellular communication arrangements include a plurality of base station transceivers (BTS) strategically positioned to provide wireless communication coverage over selected geographic areas. A mobile station (e.g., notebook computer or cellular phone) communicates with a base station transceiver over an air interface utilizing specific wireless access technology protocols. The base station transceiver communicates with a wireless network over a backhaul connection to facilitate communications between the mobile station and another device. With most such arrangements, each base station has a dedicated backhaul connection that ensures adequate signaling traffic capacity or bandwidth to allow for providing a desired quality of service to the mobile stations communicating through that base station.

With advances in wireless communication technology, it has become increasingly desirable to provide wireless coverage within buildings or other areas where existing base stations are not providing reliable wireless coverage.

Current RAN Architectures (BTS-BSC) have fundamental limitations for supporting high data rates. Range and coverage are also issues which cause unreliable, low data rate delivery at cell edges. Signal strength (in dB scale) decays log-linearly with the distance between the BTS and the mobile station. The signal to noise ratio at the cell edge is interference limited with aggressive frequency reuse targets (reuse 1 & 3). Additionally, higher frequency bands (2.3, 2.5, 3.5 GHz) are more vulnerable to non-Line-Of-Sight radio propagation losses.

Monolithic RAN architecture hierarchies include RAN backhauls (e.g., T1/E1) which are bandwidth (BW) limited, expensive (e.g., they have a monthly re-occurring cost) and designed for circuit switched voice systems. Broadband interfaces (e.g., G-Ethernet/SDH/Fiber) are expensive, not available due to regulatory and geographic restrictions or both.

One proposal in this regard has been to provide Femto base station (FBS) transceivers that can be installed by consumers within buildings, for example. A FBS establishes a much smaller area of wireless coverage compared to a typical macrocell base station transceiver.

Deploying FBSs presents special challenges to network operators. One aspect associated with the deployment of FBSs is how to provide adequate quality of service to the subscribers accessing a wireless communication network through a FBS. Current mechanisms cannot guaranty the quality of service that is desired for many wireless communications involving FBSs.

For example, it is not economic or feasible to preallocate bandwidth on a backhaul resource and dedicate that portion of the backhaul resource to a FBS. In typical scenarios, a FBS will utilize a backhaul connection such as a DSL line that is also used within a residence for other services. In current DSL deployments, the UpLink (UL) BW resources are limited and sensitive to network operations. Permanently allocating a portion of the DSL bandwidth to the FBS will undesirably prevent those resources from being utilized for other services. Moreover, a FBS typically will not be active at all times and, therefore, a pre-allocation of such resources will be wasted much, if not most, of the time.

Dynamic quality of service approaches currently in use in wireless communication networks do not address the issue of backhaul transport capacity to ensure quality of service for FBSs. Wireless network signaling protocols are not recognized by wireline packet transport networks such that backhaul resources and associated control devices are not capable of performing quality of service control in the same way that the wireless quality of service is managed. Different standard functional systems and mechanisms exist for quality of service control in wireless networks and fixed transport networks, respectively.

### SUMMARY

An exemplary method of facilitating communications involving a Femto base station (FBS) includes initiating a dedicated backhaul quality of service (QoS) request by the FBS. The request is based on at least an association between the FBS and a wireline backhaul resource used by the FBS. The QoS for the wireline backhaul resource is based on a QoS for a wireless communication session corresponding to the request.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a communication network designed according to an embodiment of this invention.

FIG. 2 is a signaling flow diagram summarizing portions of an example of the approach that FBS dynamically initiates backhaul QoS request.

FIG. 3 is a signaling flow diagram summarizing another portion of an example approach.

FIG. 4 is a flow chart diagram illustrating an example procedure

FIG. 5 is a signaling flow diagram illustrating a method of facilitating communications involving a Femto base station designed according to an embodiment of this invention.

FIG. 6 schematically illustrates selected portions of another example communication network.

### DETAILED DESCRIPTION

The following examples facilitate communications involving Femto base stations (FBSs). An association is made between a FBS and wireline backhaul resources utilized by that FBS. Quality of service parameters for a wireless communication session involving the FBS and the established association allow for determining a corresponding quality of service requirement for the wireline backhaul resource and providing that quality of service to the FBS during the wireless communication. This dynamic approach to ensuring quality of service from an end-to-end perspective for a wireless communication involving a FBS ensures quality of service over the backhaul resource in a reliable and efficient manner.

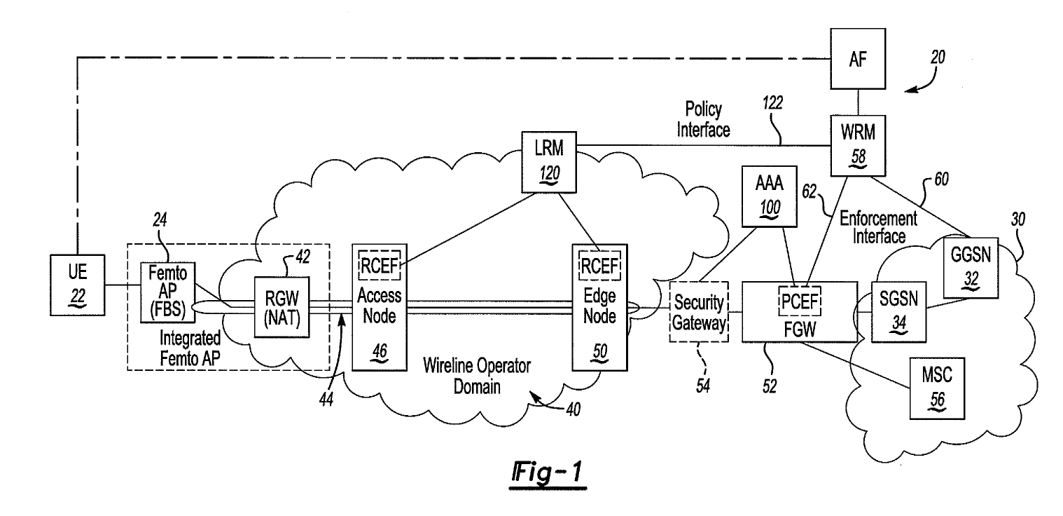

FIG. 1 schematically illustrates a communication arrangement 20 for facilitating wireless communications between a mobile station (UE) 22 and a FBS 24. In this description, the term “FBS” refers to a communication device including a transceiver that provides wireless communication coverage over a relatively small area. A FBS includes features making it an access point through which a larger communication network becomes accessible to a mobile station.

A FBS is distinct from a macrocell base station and from a picocell base station. The distinction is based primarily on the limited range of wireless coverage provided by the FBS. Another distinction is associated with how FBSs are deployed. Typical FBSs utilized in example embodiments of this invention will be installed by consumers without requiring a network operator to provide dedicated backhaul resources to the FBS. The FBS will utilize an existing connection such as a DSL connection for purposes of making a backhaul connection to the network that facilitates wireless communications on behalf of the mobile station 22.

This method is applied to a variety of core network technologies in the wireless network purview. In the example of FIG. 1, selected portions of a core network 30 operate in a generally known manner to facilitate wireless communications. In one example, the core network 30 operates according to known UMTS standards. In another example, CDMA communication standards are utilized within the core network 30. In the other example, LTE (long term evolution) standards are utilized with the core network 30. The illustrated example includes a gateway general support node (GGSN) 32 and a serving GPRS support node (SGSN) 34 and MSC 56 for UMTS network.

A wireline packet transport network portion 40 facilitates the backhaul communications between the FBS 24 and the core network 30. In this example, a residential gateway (RGW) 42 facilitates making a connection between the FBS 24 and a backhaul resource connection 44 such as a DSL line, for example. Various backhaul resource connections can be utilized, including Cable, PON and other wired network technologies. DSL is shown as only one example type of backhaul resource connection. The example backhaul resource includes an access node 46 and an edge node 50.

The example of FIG. 1 includes a Femto gateway (HNB GW) 52. A security gateway 54 facilitates a plurality of FBSs accessing the SGSN 34 for packet domain services or an MSC 56 for circuit domain services of the core network 30 for purposes of establishing wireless communication sessions on behalf of a mobile station such as the mobile station 22.

For example, a new service request or a handover is signaled by the FBS 24 over the backhaul resource 44 to the SGSN 34, which is an anchor point of Packet domain service in the core network 30. The SGSN 34 communicates with the GGSN 32 by sending a transport session creation message (i.e., create PDP context). The GGSN 32 communicates with a wireless resource manager (WRM) 58 over an interface 60 to create the transport session and obtain quality of service authorization. The WRM is a policy server for policy decision and resource control in the wireless network, one example of WRM is the Policy and Charging Control Functions (PCRF) defined in 3GPP PCC framework. The wireline resource manager (LRM) is a policy server for policy decision and resource control in the wireline network, one example of LRM is Resource and Admission Control Subsystem (RACS) defined in ETSI TISPAN, another example of LRM is PacketCable Multimedia (PCMM) defined in CableLabs PacketCable standards; the other example is Resource and Admission Control Functions (RACF) defined in ITU-T standards. In this example, the SGSN 34 or the MSC 56 sends a request toward the FBS 24 for radio access network (RAN) bearer and radio bearer creation. The FBS 24 initiates the backhaul QoS request with QoS information and UE ID etc and sends it to the FGW 52. The FGW 52 in this example is responsible for providing QoS information to the WRM 58 over an interface 62. The information for backhaul resource control includes a public IP address of RGW 42 and quality of service information from the FBS 24 including requested bandwidth.

This example includes a new dedicated femto backhaul QoS request signaling protocol (HNBQAP) that is used to trigger the backhaul QoS request from the FBS 24 to the FGW 52. A payload protocol identifier field in SCTP is set to a new value assigned by the Internet assigned numbers authority (IANA). The HNBQAP provides the signaling service between the FBS 24 and the FGW 52 required to fulfill transparent transfer of backhaul QoS request messages and an error handling function that allows for reporting general error situations for which specific error messages have not been defined. The destination port number field in SCTP is set to the value assigned by IANA for setting up the common SCTP associating in the FBS 24 and RUA.

The following table illustrates example information carried in one HNBQAP messaging strategy.

TABLE 1

| Parameter name | Description | Attribute |
|---|---|---|
| Mobile Station | e.g. IMSI or TMSI of the (U)SIM associated with the | M |
| Identity | mobile station | |
| Broadband | the information associated with the broadband | M |
| connection info | connection (e.g. DSL) the FBS is connected | |
| Backhaul | the global identity of the backhaul connection for femto | O |
| connection ID | traffic i.e. line ID | |
| Public source IP | consists of an IP address and the realm information | O |
| address of IPSec | | |
| Globally | Assigned by backhaul network, i.e. public source IP | O |
| routable IP | address of IPSec tunnel | |
| address | | |
| Address | identifies the service provider that manages the | O |
| Realm | backhaul network | |
| QoS parameters | RAN QoS derived from RAB Assignment Request | M |
| Maximum bit rate | the maximum number of bits delivered by/to RAN in a | M |
| | certain period of time | |
| Guaranteed bit | the guaranteed number of bits delivered by/to RAN in a | C |
| rate | certain period of time | |
| Traffic class | e.g. conversational, streaming, interactive and | |
| | background | |
| Transfer delay | | C |
| Traffic handling | the priority of all SDUs in a RAB compared to those in | C |
| priority | other RABs | |
| Allocation/Retention | Preemption priority of the RAB | M |
| Priority | | |

In table 1, M indicates a mandatory parameter,
O indicates an optional parameter and
C indicates a conditional parameter.

The FBS 24 decides whether an RAB assignment request is acceptable based on RAB resource status and backhaul resource availability. The FBS 24 waits for the acknowledgment of a backhaul QoS request before responding with a confirmation to the SGSN 34 or the MSC 56. The FBS 24 denies the requested RAN QoS parameters if the backhaul network indicates that it cannot provide the requested QoS.

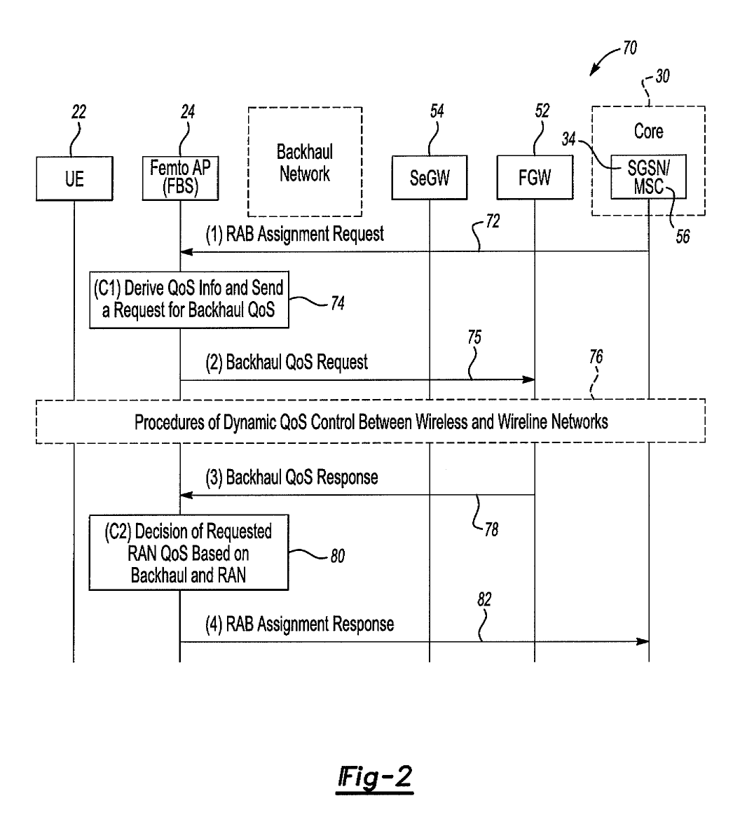

FIG. 2 is a signaling diagram 70 that summarizes an example of the approach that FBS dynamically initiates backhaul QoS request upon receiving RAN QoS request message from the core network. In this example, the FBS 24 receives a RAB assignment request at 72 from the core network. The FBS 24 checks the RAN resource status. At 74 the FBS 24 derives the information of backhaul QoS request as shown in Table 1 and initiates a HNBQAP message to the FGW 52. At 75 the FBS 24 sends the backhaul QoS request to the FGW 52. The FGW 52 starts the dynamic QoS control procedures between the wireless and wireline backhaul networks at 76. Once those procedures are completed, the FGW 52 sends a dedicated QoS response to the FBS 24 at 78 indicating the available resource information. At 80 the FBS 24 decides on the available RAN QoS. The FBS 24 then sends a RAB assignment response to the core network (SGSN 34 or MSC 56) at 82 to confirm or modify the requested QoS.

It is necessary to identify the association between the backhaul QoS request and the corresponding backhaul connection (i.e., the packet transport network and circuits) to perform dynamic QoS control over the Femto backhaul packet transport network. The public source IP address of IPSec is also needed to identify the backhaul connection. Additionally, the backhaul connection ID is optional for this purpose, which can be a circuit ID (i.e. DHCP Option 82 sub-option 1) in DSL or a service flow ID in cable. Table 2 below shows one example association of backhaul QoS request and broadband connection information.

TABLE 2

| Parameter name | Description | Attribute |
|---|---|---|
| Mobile station | e.g. IMSI or TMSI of the (U)SIM associated with the | M |
| Identity | mobile station | |
| FBS ID | a globally unique and permanent identity of the FBS | M |
| Broadband | the information associated with the broadband | M |
| connection info | connection (e.g. DSL) the FBS is connected | |
| Backhaul | the global identity of the backhaul connection for femto | O |
| connection ID | traffic i.e. line ID | |
| Public source IP | consists of an IP address and the realm information | M |
| address of IPSec | | |
| Globally | Assigned by backhaul network, i.e. public source IP | M |
| routable IP | address of IPSec tunnel. It could be the IP address of | |
| address | RGW when a NAT is deployed | |
| Address | identifies the service provider that manages the | C |
| Realm | backhaul network | |

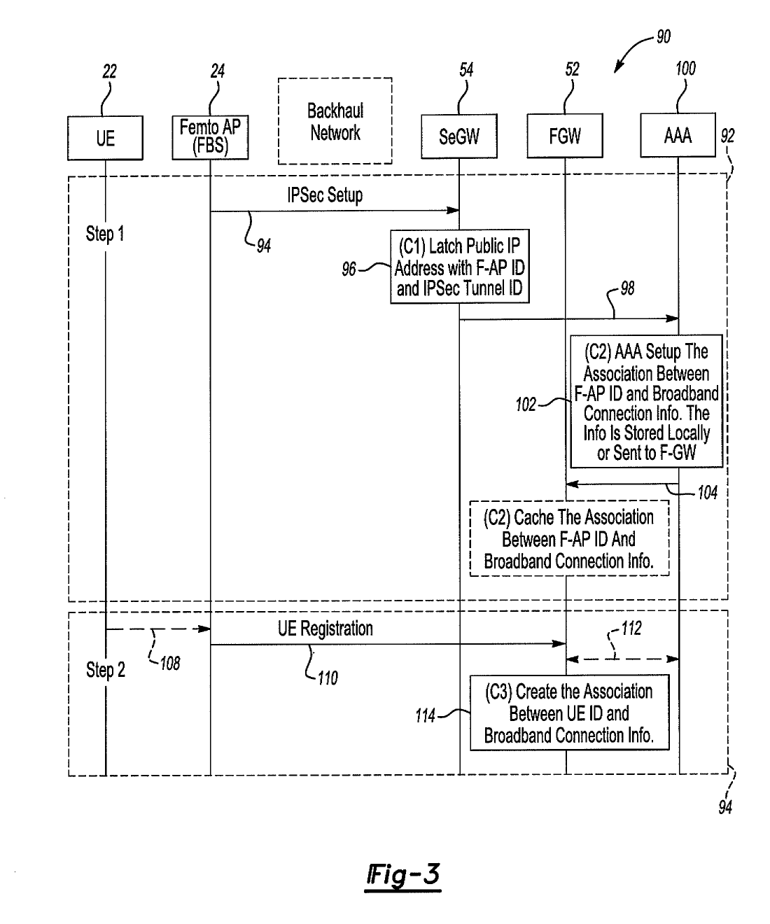

FIG. 3 schematically illustrates creating the association table in the FGW 52. The signaling diagram 90 includes two steps 92 and 94. The first step 92 begins with an IPSec setup message from the FBS 24 to the security gateway 54 at 94. As shown at 96, the security gateway 54 latches the source IP address of an exterior IP packet header as the globally routable IP address field. At 98, the security gateway 54 sends a corresponding indication to an AAA server 100. The AAA server 100 provides the authentication of FBS and UE when they register.

At 102, the AAA server 100 derives the realm information of the backhaul network based on the IPSec tunnel IP Address. In one example, the AAA server 100 uses a DNS reverse lookup method using the IPSec Tunnel Address as the index to retrieve the domain information from a DNS database. The AAA server 100 stores the information locally in one example. In the illustrated example, the AAA server 100 pushes the information down to the FGW 52 as shown at 104.

The second step 94 includes the mobile station 22 attempting to camp on the FBS 24 as shown at 108. When the FBS 24 registers the mobile station 22, the FBS 24 provides the mobile station ID to the FGW 52 at 110. At 112, the FGW 52 extracts the mobile station ID and the FBS broadband connection information from the registration request and applies the FBS ID as the key to retrieve broadband connection information from the AAA server 100 or the local cache. The FGW sets up the association between the mobile station ID and the broadband connection information for each registered mobile station at 114.

When the FGW 52 receives the HNBQAP message from the FBS 24, it uses the mobile station ID in the message as the key to look up the pertinent broadband connection information and generates a QoS request with the information in Table 3 below.

TABLE 3

| Parameter name | Description | Attribute |
|---|---|---|
| UE Identity | e.g. IMSI or TMSI of the (U)SIM associated with the UE | M |
| F-GW address | a globally unique IP address of the F-GW | M |
| Broadband | the information associated with the broadband | M |
| connection info | connection (e.g. DSL) the FBS is connected | |
| Backhaul | the global identity of the backhaul connection for femto | O |
| connection ID | traffic i.e. line ID | |
| Public source IP | consists of an IP address and the realm information | M |
| address of IPSec | | |
| Globally | Assigned by backhaul network, i.e. public source IP | M |
| routable IP | address of IPSec tunnel | |
| address | | |
| Address | identifies the service provider that manages the | C |
| Realm | backhaul network | |
| QoS parameters | RAN QoS derived from RAB Assignment Request | M |
| Maximum bit rate | the maximum number of bits delivered by/to RAN in a | M |
| | certain period of time | |
| Guaranteed bit | the guaranteed number of bits delivered by/to RAN in a | C |
| rate | certain period of time | |
| Traffic class | e.g. conversational, streaming, interactive and | |
| | background | |
| Transfer delay | | C |
| Traffic handling | the priority of all SDUs in a RAB compared to those in | C |
| priority | other RABs | |
| Allocation/Retention | Preemption priority of the RAB | M |
| Priority | | |

The FGW 52 binds to the right WRM 58 and sends the request (e.g., through CCR defined in 3GPP Gx). The information elements in Table 3 are generated by the FGW 52. That information is used by the WRM 58 and a peer wireline resource manager (LRM) 120 that dynamically interacts with the WRM 58 to perform several operations to facilitate the FBS 24 QoS request.

The dynamic interaction between the WRM 58 and the LRM 120 involves performing a policy check based on a service level agreement (SLA) and subscription profile information such as QoS class and bandwidth. Network service policy is checked in the wireless and backhaul networks, respectively. Resource admission occurs on a per session and per flow basis across the wireless network and across the backhaul packet transport network. Policy enforcement is per tunnel (e.g., IPSec) at the access node 46, the edge node 50 or both. The policy enforcement includes packet marking, policing and rate limiting.

In one example, the WRM 58 maintains the peer LRM 120 system domain information in a table. The realm in the resource request from the FGW 52 is used as a key in the table lookups. One example includes lookups based on longest match from the right on the realm rather than requiring an exact match to speed up the look up time. The realm is extracted from the realm field of the femto broadband connection information in the QoS request message sent by the FGW 52.

One example includes a per session reservation. The bandwidth in the backhaul is dynamically allocated on demand for each application session. All unused resources are fully shared between femto traffic and regular broadband traffic in such an example.

Another example method for resource admission control supported over the interface 122 between the WRM 58 and the LRM 120 includes an aggregate resource reservation. In this example, a certain amount of bandwidth in the backhaul is allocated to the femto traffic upon an initial request (e.g., during IP-CAN establishment). The reserved bandwidth is modified in some cases based on real usage and SLA. The reserved resources are not available for regular broadband traffic for that particular subscription (e.g, in the household using the DSL connection) except best effort traffic.

In the illustrated example, the WRM 58 determines whether to send the QoS request to the LRM 120 for resource admission of the backhaul. The WRM 58 makes the decision based on the SLA with the backhaul transport network operator and the resource reservation method in use. The WRM 58 checks the ACL against the realm provided in the resource request message to ensure the security and trust relationship. The WRM 120 also checks the subscription profile for the requested QoS resource.

The WRM 58 in one example maps the RAN specific QoS parameters received from the FGW 52 to generic QoS parameters based on the appropriate SLA. Table 4 includes example generic information.

TABLE 4

| | | |
|---|---|---|
| QoS parameters | Generic QoS mapping from RAN QoS | M |
| QoS Class ID | A generic QoS class reference that can be used to | M |
| | derive specific QoS class and traffic | |
| | characteristics (e.g. packet loss rate, packet delay | |
| | budget) | |
| Max Requested | the maximum number of bits delivered by/to | M |
| BW UL/DL | RAN in a certain period of time | |
| Guaranteed bit | the guaranteed number of bits delivered by/to | C |
| rate UL/DL | RAN in a certain period of time | |
| Reservation | Priority of the request | O |
| Priority | | |

The FGW 52 generates such generic QoS information in one example along with generating the requestor name and the broadband connection information.

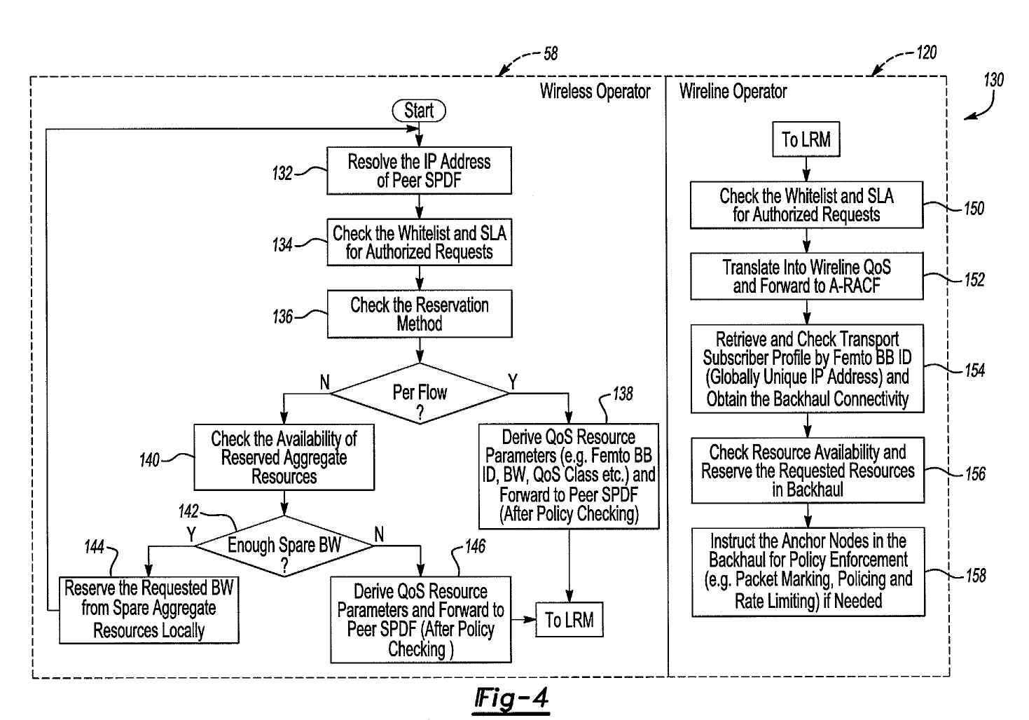

As shown in the flow chart diagram 130 of FIG. 4, at 132 the WRM 58 receives the request from the FGW 52 and resolves the IP address of the appropriate peer LRM 120 from a diameter routing table, for example. At 134 the WRM 58 checks the subscription profile or white list for authorized requests and checks the SLA. At 136 the WRM 58 checks the reservation method to determine the next operation.

If the reservation method is per flow, then the illustrated process continues at 138 where the WRM 58 sends the resource admission request to the LRM 120. If an aggregation reservation method is used, then the process proceeds to 140 where the WRM checks the availability of reserved resources. At 142 a determination is made whether the residual resources are sufficient for the new request. If so, then the WRM 58 reserves the requested bandwidth at 144. If there are insufficient resources available, the WRM 58 sends a request to increase the watermark of resource reservation at 146.

At the LRM 120, several operations occur after receiving the request from the WRM 58. The whitelist and SLA are checked for authorized requests at 150. The wireless QoS is translated into corresponding wireline QoS at 152. The LRM 120 reverse maps the generic QoS parameters to backhaul specific transport QoS parameters. Examples include DSCP, ToS and 802.1p. The subscriber profile and resource information is checked at 154. In this example, the subscriber profile and resource information such as the address of anchor network elements, circuit ID and topology are retrieved at 154. This can involve, for example, authorizing the subscription by checking the subscription policy for information such as the maximum bandwidth allowed to femto traffic per QoS class.

At 156 the resource availability is checked and the requested resources are reserved in the backhaul. One example includes checking resource utilization over a specific connection based on the topology and circuit information. Resource admission and reservation are completed based on the packet transport network policy. In this example, at 158 the policy decisions are pushed down to relevant anchor elements such as the RGW 42, the access node 46 and the edge node 50 for packet marking, policing and rate limiting operations. Some examples do not include the step at 158.

The example of FIG. 1 also includes a Application Function (AF) 160 for controlling the application session initiated from the end user such as a VoIP call from a mobile station accessing the FBS 24.

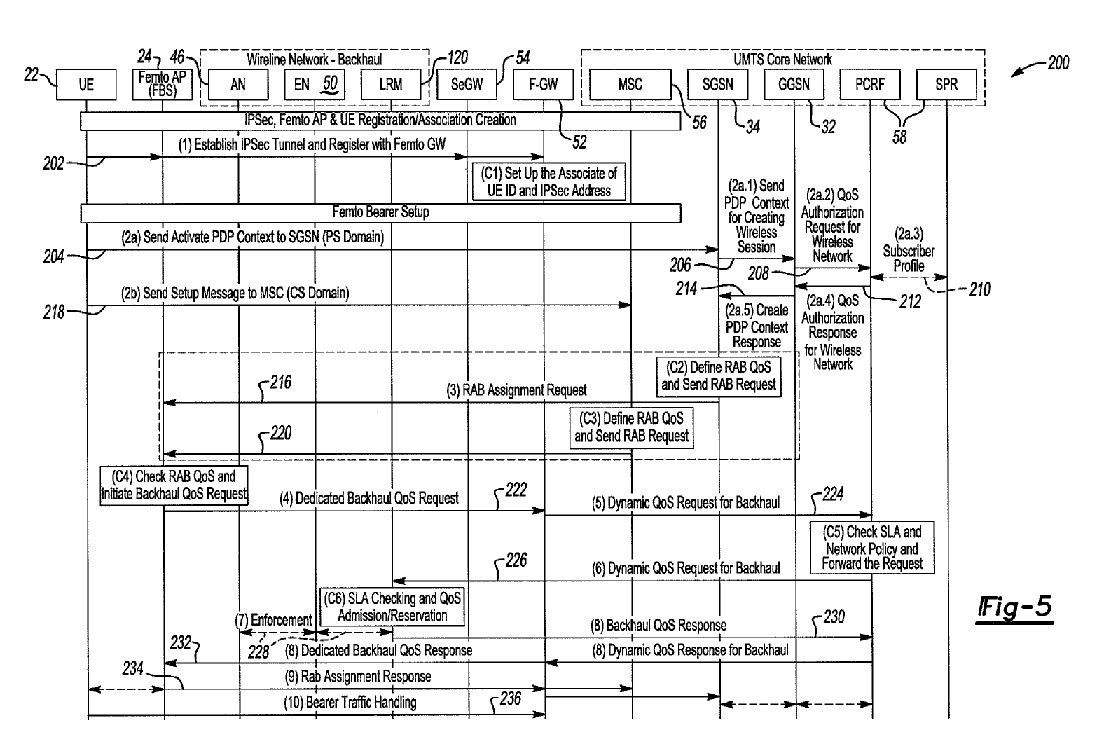

FIG. 5 includes a signaling flow diagram 200 summarizing an example approach for establishing end-to-end dynamic quality of service control for a wireless communication session involving the example FBS 24 and the example wireless station 22. As shown at 202, the FBS 24 signals the FGW 52 for establishing a secure communication tunnel over the backhaul resource 44 and registering the FBS 24 with the FGW 52. The mobile station 22 registers with the FBS 24 and that information is forwarded to the FGW 52.

One aspect of this example is that during the IPSec setup, the security gateway 54 and the AAA server 100 derive the global routable Source IP address of IPSec (i.e. Src IP@FAP or Src IP@RGW) and stores that information in the AAA. During mobile station registration, the FGW 52 and the AAA server 100 set up the association of the Src IP address of IPSec and FBS ID and store that information in the FGW 52 or in the AAA server 100. In the latter case, that information is retrieved by the FGW 52 when receiving the QoS request.

When a user of the mobile station 22 desires to make a call, the mobile station 22 sends a service request to core network. This may go to the SGSN 34 or the MSC 56. In the case of PS domain as shown at 204, the wireless core network 30 and more specifically the SGSN 34 receives the request message for transport session (e.g. PDP Context) establishment due to the new service request or handover. The SGSN 34 sends a transport session creation message (i.e. Create PDP Context) to the gateway (i.e. GGSN 32) at 206. The GGSN 32 sends a request at 208 to the PCRF portion of the WRM 58 to authorize the QoS for wireless network and create the transport session. That occurs at 210 and 212 and the WRM notifies the GGSN 32. After the authorization, the GGSN 32 confirms the PDP Context to the SGSN at 214.

As shown at 216, in the case of CS domain, the MSC 56 receives the setup message and defines the initial QoS attributes. At 216 and 220, respectively, the SGSN 34 and the MSC 56 send a Radio Access Bearer Assignment Request to the FBS 24. The FBS 24 checks the RAN QoS resources and generates QoS request information for the backhaul.

As those skilled in the art will appreciate, either the signaling at 204-216 or the signaling at 218-220 will occur depending on the domain. It is also possible for both to occur. Both possibilities are shown in the example of FIG. 5 for discussion purposes.

At 222, the FBS 24 sends the QoS request (by sending a HNBQAP message) towards the FGW 52, including the mobile station ID, RAN QoS information and broadband connection information (if available). This aspect of the illustrated example is unique in that the FBS 24 initiates the backhaul QoS request.

As shown at 224, the FGW 52 retrieves the Src IP address of IPSec based on the mobile station ID and forwards the QoS request (including the mobile station ID, source IP address of IPSec/RGW, RAN QoS information, etc.) to the WRM 58 in the same SP domain through a Gxx interface. The WRM 58 checks the subscription profile and SLA, translates RAN QoS to generic QoS based on SLA, discovers the backhaul operator and, as shown at 226, forwards the QoS request to the appropriate peer LRM 120. The LRM 120 checks the resource availability and at 228 sends appropriate signals to the related nodes (e.g. DSLAM, BNG router) to enforce the rules if appropriate. The DSLAM/BNG may police the femto traffic at the aggregate level to assure the maximum bandwidth, for example. In the case the Broadband circuit ID is not provided in the request, the LRM 120 can retrieve it from a NASS using the source IP address as an index.

At 230, the LRM 120 acknowledges the request and sends back confirmation to the WRM 58 which then forwards the acknowledgment to the FBS 24 as shown at 232. After receiving the uplink femto packets, the FBS 24 ensures the inner IP QoS marking is inline with the authorized QoS class, and mapped to the outer header (IPSec) based on a predetermined mapping rule. The FBS 24 sends a RAB Assignment Response at 234 to the core network through the FGW 52.

At 236 the backhaul (RGW, DSLAM, BNG) forwards the packet based on the DSCP in the outer header to facilitate handling the bearer traffic.

One aspect of this approach is that it allows for dynamically making a backhaul resource allocation to ensure quality of service for a FBS 24 for a particular wireless communication session. Once that session is complete, those resources of the backhaul transport network are released and become available for a different wireless communication session involving the same devices or different devices, depending on the situation. Dynamically assigning backhaul resources to ensure quality of service avoids having to pre-configure and constantly dedicate particular backhaul resources to one or more FBS's.

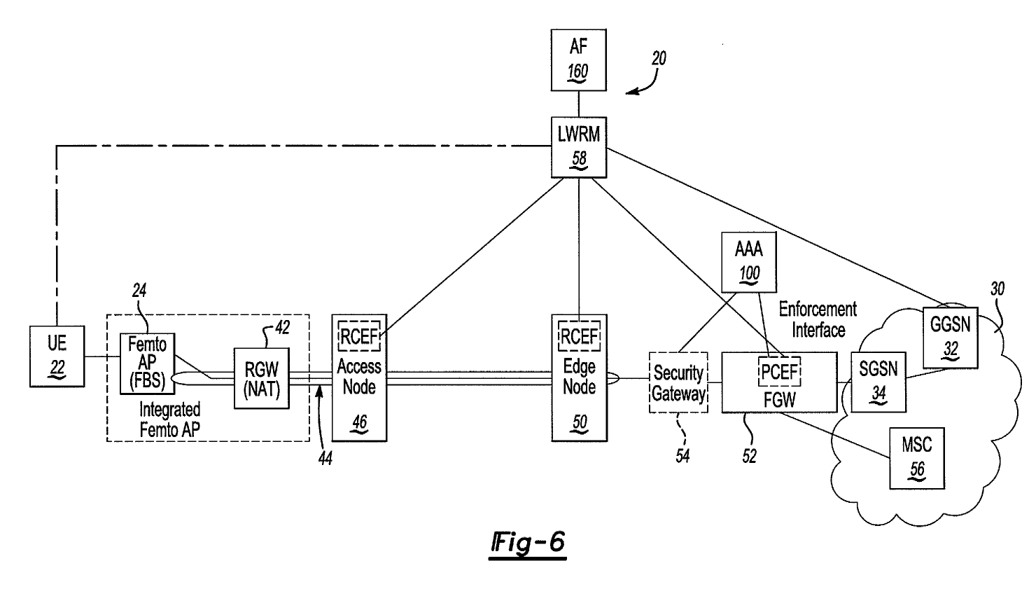

The above example is applicable to situations in which there are separate operators of the wireless network 30 and the wireline packet transport network 40 for the backhaul. The same example can be used when there is a single operator managing both networks. In a situation where there is a single operator responsible for the Femto wireless network and the wireline packet transport network for the backhaul, the implementation can be modified as shown in FIG. 6 compared to that shown in FIG. 1. In this example, the functionality of the LRM 120 and the WRM 58 are collapsed into a LWRM (Wireline and Wireless Resource Manager) 58. The interface between the FGW 53 and LWRM 58 remains the same. The example methodology described above is applicable to this example.

The example dynamic quality of service control is applicable to various scenarios when a Femto bearer connection (i.e., IP-CAN session and bearers) is created or modified. The situations may involve establishing or modifying quality of service attributes. For example, a mobile station 22 previously in an idle mode initiates a service request procedure to send uplink signaling messages or data. Alternatively, core elements of the wireless core network 30 may initiate a service request procedure.

Another use for the dynamic quality of service control includes a handover where a mobile station moves from one routing area to another. Example routing area updates include intra-SGSN routing area updates or inter-SGSN routing area updates. Serving radio network controller relocations include intra-SGSN SRNS relocation or an intra-SGSN routing area update.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of facilitating communications involving a Femto base station (FBS), comprising the steps of:
initiating a dedicated backhaul quality of service (QoS) request by the FBS, the request being based on at least an association between the FBS and a wireline backhaul resource used by the FBS; and
utilizing a QoS for the wireline backhaul resource that is based on a QoS for a wireless communication session corresponding to the request.

2. The method of claim 1, comprising releasing the wireline backhaul resource upon termination of the wireless communication session.

3. The method of claim 1, comprising establishing the association by
receiving a registration request from the FBS at a gateway;
associating an identifier of the FBS with the wireline backhaul resource;
receiving a registration message regarding a mobile station provided by the FBS to the gateway;
associating an identifier of the mobile station with the associated FBS identifier and the wireline backhaul resource.

4. The method of claim 3, wherein the gateway comprises a Femto gateway that interfaces with an anchor point of a wireless communication network that facilitates the wireless communication session.

5. The method of claim 1, comprising
granting the received request if at least one of a service level agreement or a network policy accommodate the received request.

6. The method of claim 5, comprising mapping quality of service parameters of the QoS information for the wireless communication session to QoS parameters useful for the wireline quality of service.

7. The method of claim 1, comprising using a public Internet Protocol address of an IPSec tunnel or a radio gateway in relation to the FBS to identify the wireline backhaul resource in the association.

8. The method of claim 1, comprising
communicating between a wireless resource manager and a wireline resource manager for determining the corresponding quality of service requirement of the wireline backhaul resource.

9. The method of claim 8, comprising
checking a subscription profile of the FBS or a mobile station registered with the FBS for determining an allowable QoS.

10. The method of claim 1, wherein the wireline backhaul resource is part of a packet transport network.
